(19) United States
(12) Patent Application Publication
(10) Pub. No.: US 2023/0309038 A1
(43) Pub. Date: Sep. 28, 2023

(54) METHOD AND APPARATUS FOR SS/PBCH BLOCK FREQUENCY LOCATION INDICATION AND MULTI-SLOT PDCCH MONITORING

(71) Applicant: Samsung Electronics Co., Ltd., Suwon-si (KR)

(72) Inventors: Hongbo Si, Plano, TX (US); Qiongjie Lin, Sunnyvale, CA (US)

(21) Appl. No.: 18/180,080

(22) Filed: Mar. 7, 2023

Related U.S. Application Data
(60) Provisional application No. 63/322,529, filed on Mar. 22, 2022.
(60) Provisional application No. 63/323,623, filed on Mar. 25, 2022.
(60) Provisional application No. 63/343,676, filed on May 19, 2022.

(51) Int. Cl. H04W 56/00; H04W 72/23

(52) U.S. Cl. CPC H04W 56/0015; H04W 72/23

(57) ABSTRACT

Methods and apparatuses for synchronization signal and physical broadcast channel (SS/PBCH) block frequency location indication and multi-slot physical downlink control channel (PDCCH) monitoring in a wireless communication system A method of a user equipment (UE) includes receiving a first SS/PBCH block; determining a value of k_{SSB} based on the first SS/PBCH block; determining that a first control resource set (CORESET) for a Type0-PDCCH common search space (CSS) set is not present; and determining a global synchronization channel number (GSCN) of a second SS/PBCH block as N_{GSCN}^{Reference}+N_{GSCN}^{Offset}·N_{GSCN}^{Step}, when the value of k_{SSB} is within a range. The first CORESET is associated with the first SS/PBCH block. A second CORESET for a Type0-PDCCH CSS set associated with the second SS/PBCH block is present. The method further includes receiving the second SS/PBCH block according to the determined GSCN of the second SS/PBCH block.

### CROSS-REFERENCE TO RELATED APPLICATIONS AND CLAIM OF PRIORITY

The present application claims priority to:
U.S. Provisional Patent Application No. 63/322,529, filed on Mar. 22, 2022;
U.S. Provisional Patent Application No. 63/323,623, filed on Mar. 25, 2022; and
U.S. Provisional Patent Application No. 63/343,676, filed on May 19, 2022. The contents of the above-identified patent documents are incorporated herein by reference.

### TECHNICAL FIELD

The present disclosure relates generally to wireless communication systems and, more specifically, the present disclosure relates to enhancements to synchronization signal and physical broadcast channel (SS/PBCH) block frequency location indication and multi-slot physical downlink control channel (PDCCH) monitoring in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to enhancement to SS/PBCH block frequency location indication in a wireless communication system and multi-slot PDCCH monitoring.

In one embodiment, a base station (BS) in a wireless communication system is provided. The BS includes a processor configured to determine a value of k_{SSB} for a first SS/PBCH block; determine that a first control resource set (CORESET) for a Type0-PDCCH common search space (CSS) set is not present; and determine a global synchronization channel number (GSCN) of a second SS/PBCH block as N_{GSCN}^{Reference}+N_{GSCN}^{Offset}·N_{GSCN}^{Step}, when the value of k_{SSB} is within a range. The first CORESET is associated with the first SS/PBCH block. A second CORESET for a Type0-PDCCH CSS set associated with the second SS/PBCH block is present. The GSCN is a nearest GSCN in a corresponding frequency direction compared to the first SS/PBCH block. N_{GSCN}^{Reference} is a GSCN of the first SS/PBCH block. N_{GSCN}^{Offset} is a GSCN offset that is based on the first SS/PBCH block. N_{GSCN}^{Step} is a GSCN step size that is based on a frequency range associated with the wireless communication system. The BS further includes transceiver operably coupled to the processor. The transceiver is configured to transmit the first SS/PBCH block according to the GSCN of the first SS/PBCH block and transmit the second SS/PBCH block according to the GSCN of the second SS/PBCH block.

In another embodiment, a user equipment (UE) in a wireless communication system is provided. The UE includes a transceiver configured to receive a first SS/PBCH block and a processor operably coupled to the transceiver. The processor is configured to determine a value of k_{SSB} based on the first SS/PBCH block; determine that a first CORESET for a Type0-PDCCH CSS set is not present; and determine a GSCN of a second SS/PB CH block as N_{GSCN}^{Reference}+N_{GSCN}^{Offset}·N_{GSCN}^{Step}, when the value of k_{SSB} is within a range. The first CORESET is associated with the first SS/PBCH block. A second CORESET for a Type0-PDCCH CSS set associated with the second SS/PBCH block is present. The GSCN is a nearest GSCN in a corresponding frequency direction compared to the first SS/PBCH block. N_{GSCN}^{Reference} is a GSCN of the first SS/PBCH block. N_{GSCN}^{Offset} is a GSCN offset that is based on the first SS/PBCH block. N_{GSCN}^{Step} is a GSCN step size that is based on a frequency range associated with the wireless communication system. The transceiver is further configured to receive the second SS/PBCH block according to the determined GSCN of the second SS/PBCH block.

In yet another embodiment, a method of a user equipment (UE) in a wireless communication system is provided. The method includes receiving a first SS/PBCH block; determining a value of k_{SSB} based on the first SS/PBCH block; determining that a first CORESET for a Type0-PDCCH CSS set is not present; and determining a GSCN of a second SS/PBCH block as N_{GSCN}^{Reference}+N_{GSCN}^{Offset}·N_{GSCN}^{Step}, when the value of k_{SSB} is within a range. The first CORESET is associated with the first SS/PBCH block. A second CORESET for a Type0-PDCCH CSS set associated with the second SS/PBCH block is present. The GSCN is a nearest GSCN in a corresponding frequency direction compared to the first SS/PBCH block. N_{GSCN}^{Reference} is a GSCN of the first SS/PBCH block. N_{GSCN}^{Offset} is a GSCN offset that is based on the first SS/PBCH block. N_{GSCN}^{Step} is a GSCN step size that is based on a frequency range associated with the wireless communication system. The method further includes receiving the second SS/PBCH block according to the determined GSCN of the second SS/PBCH block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of an indication of the location of the second SS/PBCH block according to embodiments of the present disclosure;

FIG. 7 illustrates a flowchart of a method for UE procedure for determining the frequency location of a second SS/PBCH block based on the information of a first SS/PBCH block according to embodiments of the present disclosure;

FIG. 8 illustrates a flowchart of a method for UE according to embodiments of the present disclosure;

FIG. 9 illustrates another flowchart of a method for UE according to embodiments of the present disclosure; and

FIG. 10 illustrates yet another flowchart of a method for UE according to embodiments of the present disclosure.

### DETAILED DESCRIPTION

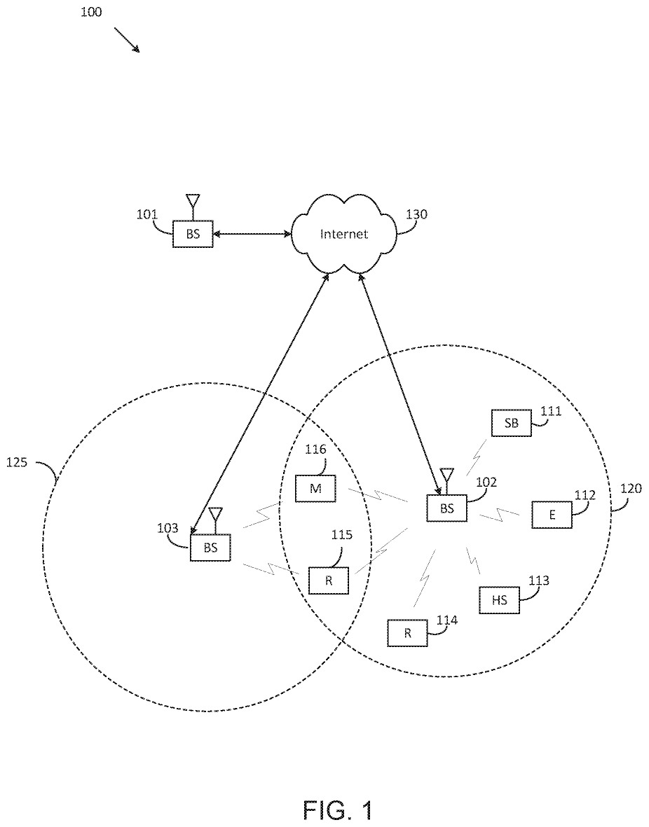

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.6.0, “NR; Physical channels and modulation”; 3GPP TS 38.212 v16.6.0, “NR; Multiplexing and Channel coding”; 3GPP TS 38.213 v16.6.0, “NR; Physical Layer Procedures for Control”; 3GPP TS 38.214 v16.6.0, “NR; Physical Layer Procedures for Data”; 3GPP TS 38.321 v16.5.0, “NR; Medium Access Control (MAC) protocol specification;” and 3GPP TS 38.331 v16.5.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for enhancement to SS/PBCH block frequency location indication and multi-slot PDCCH monitoring in a wireless communication system. In certain embodiments, and one or more of the gNBs 101-103 includes circuitry, programing, or a combination thereof, for enhancement to SS/PBCH block frequency location indication and multi-slot PDCCH monitoring in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

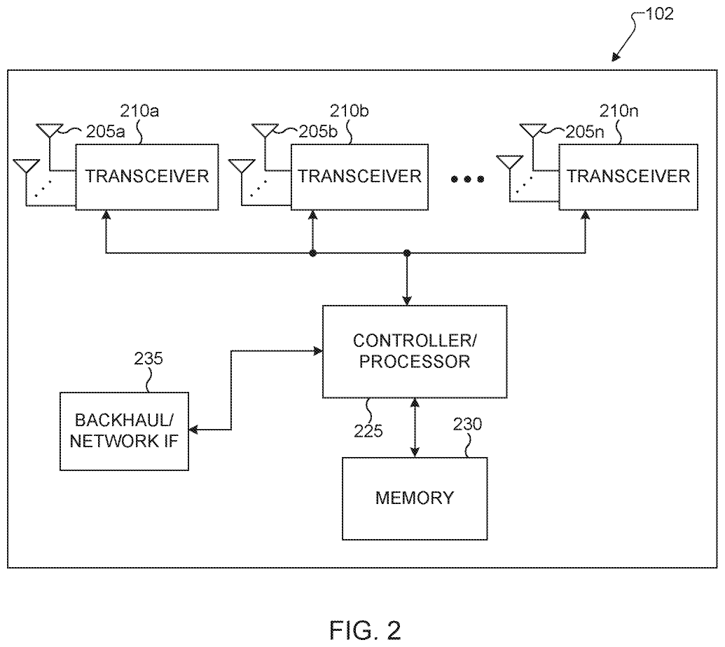

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for enhancement to SS/PBCH block frequency location indication and multi-slot PDCCH monitoring in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

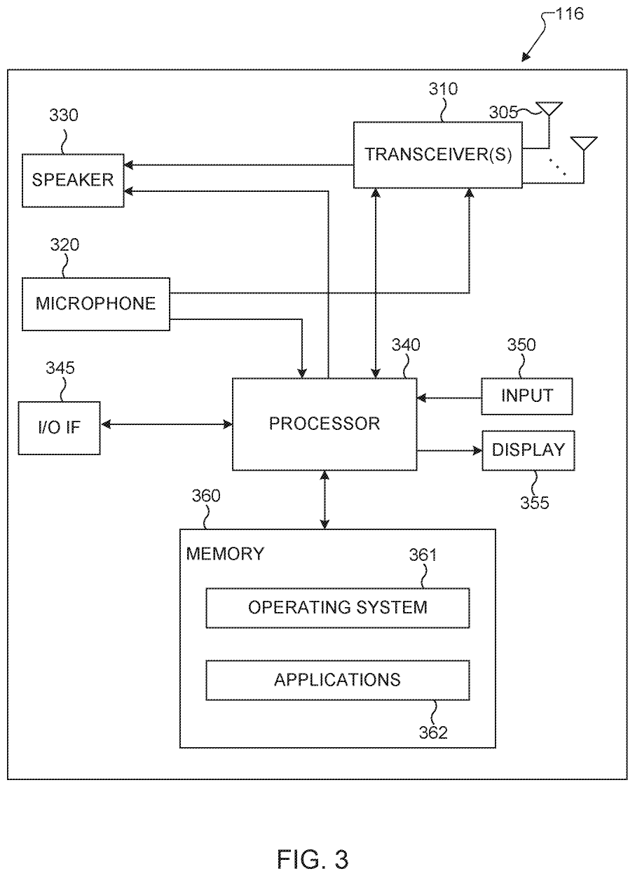

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for enhancement to SS/PBCH block frequency location indication and multi-slot PDCCH monitoring in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

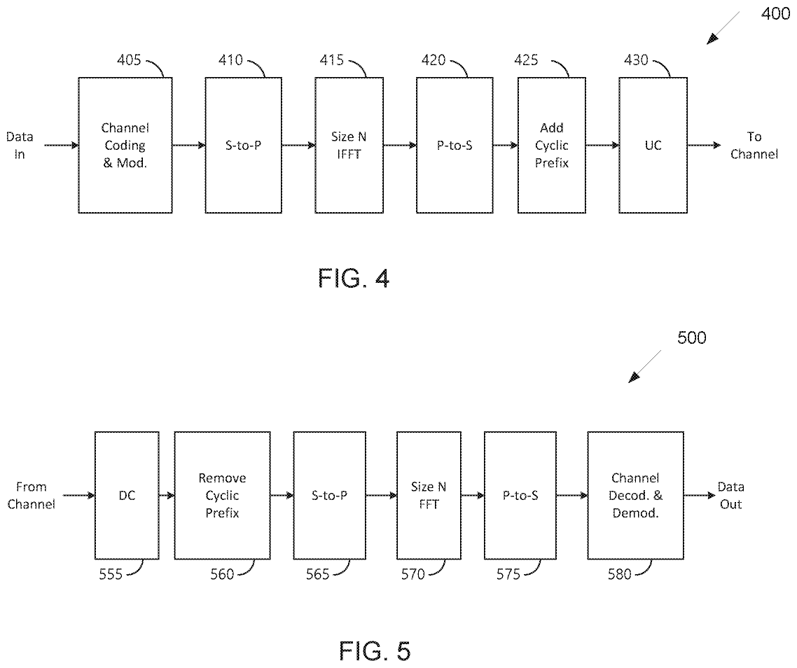

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

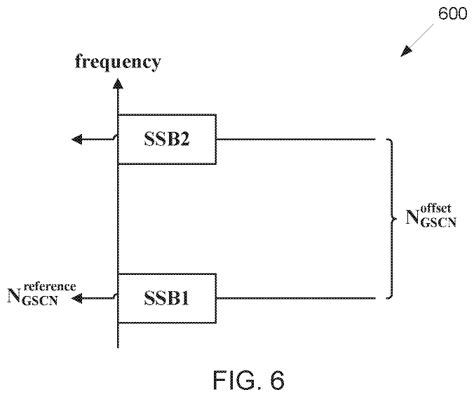

In NR Rel-15, a subcarrier spacing (SCS) of a SS/PBCH block can be one of 15 kHz or 30 kHz for frequency range 1 (FR1), and one of 120 kHz or 240 kHz for frequency range 2 (FR2). When a first SS/PBCH block does not have an associated CORESET for Type0-PDCCH CSS set present, the UE can utilize the value of k_{SSB} and the higher layer parameters controlResourceSetZero and searchSpaceZero in pdcch-ConfigSIB1 to determine information on the presence of a second SS/PBCH block with associated CORESET for Type0-PDCCH CSS set, or to determine a range within which SS/PBCH block with associated CORESET for Type0-PDCCH CSS set does not present. An illustration of the indication is shown in FIG. 6.

FIG. 6 illustrates an example of an indication of the location of the second SS/PBCH block 600 according to embodiments of the present disclosure. An embodiment of the indication of the location of the second SS/PBCH block 600 shown in FIG. 6 is for illustration only.

For one example, for FR1, if a UE detects a first SS/PBCH block and determines that a CORESET for Type0-PDCCH CSS set is not present and 24≤k_{SSB}≤29, the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Offset}·N_{GSCN}^{Reference} is the GSCN of the first SS/PBCH block and N_{GSCN}^{Offset} is a GSCN offset wherein the mapping between the combination of k_{SSB} and controlResourceSetZero and searchSpaceZero in pdcch-ConfigSIB1 to N_{GSCN}^{Offset} is given by TABLE 1.

For another example, for FR2, if a UE detects a first SS/PBCH block and determines that a CORESET for Type0-PDCCH CSS set is not present and 12≤k_{SSB}≤13, the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Offset}·N_{GSCN}^{Reference} is the GSCN of the first SS/PBCH block and N_{GSCN}^{Offset} is a GSCN offset wherein the mapping between the combination of k_{SSB} and controlResourceSetZero and searchSpaceZero in pdcch-ConfigSIB1 to N_{GSCN}^{Offset} is given by TABLE 2.

TABLE 1
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | Reserved, Reserved, . . . , Reserved |

TABLE 2
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | Reserved, Reserved, . . . , Reserved |

For a higher carrier frequency range (e.g., 52.6 to 71 GHz), there could be new SCS supported for SS/PBCH block, and new bands including the SS/PBCH block with new SCS supported. For the new SCS and new bands, the NR Rel-15 mechanism on indicating a second SS/PBCH block with associated CORESET for Type0-PDCCH CSS set present may not be sufficient, and enhancement is needed. Also, for legacy carrier frequency range, new bands with higher channel bandwidth can be supported, and indication range from Rel-15 may not be sufficient, hence, enhancement is also needed.

The present disclosure provides embodiments for enhancement to SS/PBCH block frequency location indication, based on information from another SS/PBCH block without associated CORESET for Type0-PDCCH CSS set. More precisely, the following components are focused on the present disclosure.

Enhanced SS/PBCH block frequency location indication method: (1) enlarge the value range by using reserved states in the table; (2) introduce a step size to GSCN offset; (3) combination of (1) and (2), (4) determine offset from the applicable GSCN entries, and (5) combination of (1) and (4).

In one embodiment, the indicated value range for the GSCN offset (e.g., N_{GSCN}^{Offset}) to determine a second SS/PBCH block that the associated CORESET for Type0-PDCCH CSS set is present can be enhanced (e.g., to a larger value range), wherein the indication is based a value of k_{SSB} and higher layer parameter pdcch-ConfigSIB1 (including controlResourceSetZero and searchSpaceZero) provided by a first SS/PBCH block.

For one aspect, this embodiment can be applicable to a higher frequency range (e.g., FR2-2, 52.6 to 71 GHz).

For another aspect, this embodiment can be applicable to the frequency range 1 (e.g., FR1).

For yet another aspect, this embodiment can be applicable to the frequency range (e.g., FR2) that includes the higher frequency range (e.g., FR2-2, 52.6 to 71 GHz).

For yet another aspect, this embodiment can be applicable to all frequency ranges (e.g., FR1 and FR2) that includes the higher frequency range (e.g., FR2-2, 52.6 to 71 GHz).

For yet another aspect, this embodiment can be applicable to a subcarrier spacing of the SS/PBCH block as 120 kHz.

For yet another aspect, this embodiment can be applicable to a subcarrier spacing of the SS/PBCH block as at least one of 120 kHz, 480 kHz, or 960 kHz.

For yet another aspect, this embodiment can be applicable to all subcarrier spacings of the SS/PBCH block, including 120 kHz.

The example of this embodiment can be supported per frequency range, e.g., a first example of this embodiment is supported for FR1, and/or a second example of this embodiment is supported for FR2 or FR2-2.

For one example, if a UE detects a first SS/PBCH block and determines that a CORESET for Type0-PDCCH CSS set is not present and for a range of values for k_{SSB} (e.g., 24≤k_{SSB}≤30 for FR1 and/or 12≤k_{SSB}≤14 for FR2), the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Offset}·N_{GSCN}^{Reference} is the GSCN of the first SS/PBCH block and N_{GSCN}^{Offset} is a GSCN offset determined based on a value of k_{SSB} and higher layer parameter pdcch-ConfigSIB1 (including controlResourceSetZero and searchSpaceZero) provided by a first SS/PBCH block.

In one sub-example, for FR1, the mapping between the combination of k_{SSB} and controlResourceSetZero and searchSpaceZero in pdcch-ConfigSIB1 to NN_{GSCN}^{Offset} is given by TABLE 3.

TABLE 3
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | 769, 770, . . . , 896, −769, −770, |
| | | . . . , −896 |

In another sub-example, for FR1, the mapping between the combination of k_{SSB} and controlResourceSetZero and searchSpaceZero in pdcch-ConfigSIB1 to N_{GSCN}^{Offset} is given by TABLE 4.

TABLE 4
Example mapping between the combination of
k_{SSB} and controlResourceSetZero and searchSpaceZero
in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | −769, −770, . . . , −896, |
| | | 769, 770, . . . , 896 |

In yet another sub-example, for FR1, the mapping between the combination of k_{SSB} and controlResourceSetZero and searchSpaceZero in pdcch-ConfigSIB1 to N_{GSCN}^{Offset} is given by TABLE 5.

TABLE 5
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | 769, −769, |
| | | 770, −770, . . . , 896, −896 |

In yet another sub-example, for FR1, the mapping between the combination of k_{SSB} and controlResourceSetZero and searchSpaceZero in pdcch-ConfigSIB1 to N_{GSCN}^{Offset} is given by TABLE 6.

TABLE 6
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | −769, 769, −770, |
| | | 770, . . . , −896, 896 |

In yet another sub-example, for FR1, the mapping between the combination of k_{SSB} and controlResourceSetZero and searchSpaceZero in pdcch-ConfigSIB1 to N_{GSCN}^{Offset} is given by TABLE 7, wherein X₁ is an integer, e.g., X₁=832.

TABLE 7
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 127 | 769, 770, . . . , X₁, |
| | | reserved, . . . , reserved |
| 30 | 128, 129, . . . , 255 | −769, −770, . . . , −X₁, |
| | | reserved, . . . , reserved |

In another sub-example, for FR1, the mapping between the combination of k_{SSB} and controlResourceSetZero and searchSpaceZero in pdcch-ConfigSIB1 to N_{GSCN}^{Offset} is given by TABLE 8, wherein X₁ is an integer, e.g., X₁=832.

TABLE 8
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 127 | −769, −770, . . . , −X₁, |
| | | reserved, . . . , reserved |
| 30 | 128, 129, . . . , 255 | 769, 770, . . . , X₁, |
| | | reserved, . . . , reserved |

In yet another sub-example, for FR1, the mapping between the combination of k_{SSB} and controlResourceSetZero and searchSpaceZero in pdcch-ConfigSIB1 to N_{GSCN}^{Offset} is given by TABLE 9, wherein X₁ is an integer, e.g., X₁=832.

TABLE 9
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 2, . . . , 254 | 769, 770, . . . , X₁, |
| | | reserved, . . . , reserved |
| 30 | 1, 3, . . . , 255 | −769, −770, . . . , −X₁, |
| | | reserved, . . . , reserved |

In yet another sub-example, for FR1, the mapping between the combination of k_{SSB} and controlResourceSetZero and searchSpaceZero in pdcch-ConfigSIB1 to N_{GSCN}^{Offset} is given by TABLE 10, wherein X₁ is an integer, e.g., X₁=832.

TABLE 10
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 2, . . . , 254 | −769, −770, . . . , −X₁, |
| | | reserved, . . . , reserved |
| 30 | 1, 3, . . . , 255 | 769, 770, . . . , X₁, |
| | | reserved, . . . , reserved |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 11.

TABLE 11
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | 257, 258, . . . , |
| | | 384, −257, −258, . . . , −384 |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 12.

TABLE 12
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | −257, −258, . . . , −384, |
| | | 257, 258, . . . , 384 |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 13.

TABLE 13
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | 257, −257, |
| | | 258, −258, . . . , 384, −384 |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 14.

TABLE 14
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | −257, 257, −258, |
| | | 258, . . . , −384, 384 |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 15, wherein X₂ is an integer, e.g., X₂=285.

TABLE 15
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 127 | 257, 258, . . . , X₂, |
| | | reserved, . . . , reserved |
| 14 | 128, 129, . . . , 255 | −257, −258, . . . , −X₂, |
| | | reserved, . . . , reserved |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 16, wherein X₂ is an integer, e.g., X₂=285.

TABLE 16
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 127 | −257, −258, . . . , −X₂, |
| | | reserved, . . . , reserved |
| 14 | 128, 129, . . . , 255 | 257, 258, . . . , X₂, |
| | | reserved, . . . , reserved |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 17, wherein X₂ is an integer, e.g., X₂=285.

TABLE 17
Mapping between the combination of k_{SSB} and controlResourceSetZero
and searchSpaceZero in pdcch-ConfigSIB1 to N_{GSCN}^{Offset}.

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 2, . . . , 254 | 257, 258, . . . , X₂, |
| | | reserved, . . . , reserved |
| 14 | 1, 3, . . . , 255 | −257, −258, . . . , −X₂, |
| | | reserved, . . . , reserved |

In yet another sub-example, for FR2 or FR2-2, the mapping between the combination of k_{SSB} and controlResourceSetZero and searchSpaceZero in pdcch-ConfigSIB1 to N_{GSCN}^{Offset} is given by TABLE 18, wherein X₂ is an integer, e.g., X₂=285.

TABLE 18
Mapping between the combination of k_{SSB} and controlResourceSetZero
and searchSpaceZero in pdcch-ConfigSIB1 to N_{GSCN}^{Offset}

| | 16 × | |
|---|---|---|
| | controlResourceSetZero + | |
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 2, . . . , 254 | −257, −258, . . . , −X₂, |
| | | reserved, . . . , reserved |
| 14 | 1, 3, . . . , 255 | 257, 258, . . . , X₂, |
| | | reserved, . . . , reserved |

For another example, if a UE detects a first SS/PBCH block and determines that a CORESET for Type0-PDCCH CSS set is not present and for a range of values for k_{SSB} (e.g., 24≤k_{SSB}≤29 for FR1 and/or 12≤k_{SSB}≤13 for FR2), the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Offset}·N_{GSCN}^{Step}·N_{GSCN}^{Reference} is the GSCN of the first SS/PBCH block and N_{GSCN}^{Offset} is a GSCN offset determined based on a value of k_{SSB} and higher layer parameter pdcch-ConfigSIB1 (including controlResourceSetZero and searchSpaceZero) provided by a first SS/PBCH block (e.g., the mapping between the combination of k_{SSB} and controlResourceSetZero and searchSpaceZero in pdcch-ConfigSIB1 to N_{GSCN}^{Offset} is given by TABLE 1 for FR1, or TABLE 2 for FR2).

In one sub-example, for FR1, N_{GSCN}^{Step}=1.

In another sub-example, for FR2, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or TS 38.101-2.

In yet another sub-example, for FR2-1, N_{GSCN}^{Step}=1.

In yet another sub-example, for FR2-2, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or 38.101-2.

In yet another sub-example, for all frequency ranges, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or TS 38.101-2 for FR2, or by TS 38.104 or TS 38.101-1 for FR1.

In yet another sub-example, N_{GSCN}^{Step} can be a fixed integer for at least one of FR1, FR2, or FR2-2 (e.g., can take different integer value per frequency range and/or per the SCS of the SS/PBCH block (e.g., the first and/or the second SS/PBCH block)).

For one instance, for FR1, N_{GSCN}^{Step}=1.

For another instance, for FR2-1, N_{GSCN}^{Step}=1.

For yet another instance, for FR2-2, N_{GSCN}^{Step}=3.

For yet another instance, for FR2-2 for 120 kHz, N_{GSCN}^{Step}=3.

For yet another instance, for FR2-2 for 480 kHz, N_{GSCN}^{Step}=12.

For yet another instance, for FR2-2 for 960 kHz, N_{GSCN}^{Step}=6.

For yet another instance, for FR2-2 for 960 kHz, N_{GSCN}^{Step}=1.

For yet another example, if a UE detects a first SS/PBCH block and determines that a CORESET for Type0-PDCCH CSS set is not present and for a range of values for k_{SSB} (e.g., 24≤k_{SSB}≤30 for FR1 and/or 12≤k_{SSB}≤14 for FR2), the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Offset}·N_{GSCN}^{Step}·N_{GSCN}^{Reference} is the GSCN of the first SS/PBCH block and N_{GSCN}^{Offset} is a GSCN offset determined based on a value of k_{SSB} and higher layer parameter pdcch-ConfigSIB1 (including controlResourceSetZero and searchSpaceZero) provided by a first SS/PBCH block.

In one sub-example, for FR1, the mapping between the combination of k_{SSB} and controlResourceSetZero and searchSpaceZero in pdcch-ConfigSIB1 to NN_{GSCN}^{Offset} is given by at least one of TABLE 3 to TABLE 10, wherein X₁ is an integer in the tables applicable, e.g., X₁=832.

In another sub-example, for FR2 or FR2-2, the mapping between the combination of k_{SSB} and controlResourceSetZero and searchSpaceZero in pdcch-ConfigSIB1 to N_{GSCN}^{Offset} is given by at least one of TABLE 11 to TABLE 18, wherein X₂ is an integer in the tables applicable, e.g., X₂=285.

In one sub-example, for FR1, N_{GSCN}^{Step}=1.

In another sub-example, for FR2, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or TS 38.101-2.

In yet another sub-example, for FR2-1, N_{GSCN}^{Step}=1.

In yet another sub-example, for FR2-2, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or TS 38.101-2.

In yet another sub-example, for all frequency ranges, N_{GSCN}^{Step} is the step size of the GSCN for applicable synchronization raster entries per operating band, according to the SCS of the SS/PBCH block (e.g., the first and/or the second SS/PBCH block), e.g., given by TS 38.104 or TS 38.101-2 for FR2, or by TS 38.104 or TS 38.101-1 for FR1.

In yet another sub-example, N_{GSCN}^{Step} can be a fixed integer for at least one of FR1, FR2, or FR2-2 (e.g., can take different integer value per frequency range and/or per the SCS of the SS/PBCH block (e.g., the first and/or the second SS/PBCH block)).

For one instance, for FR1, N_{GSCN}^{Step}=1.

For another instance, for FR2-1, N_{GSCN}^{Step}=1.

For yet another instance, for FR2-2, N_{GSCN}^{Step}=3.

For yet another instance, for FR2-2 for 120 kHz, N_{GSCN}^{Step}=3.

For yet another instance, for FR2-2 for 480 kHz, N_{GSCN}^{Step}=12.

For yet another instance, for FR2-2 for 960 kHz, N_{GSCN}^{Step}=6.

For yet another instance, for FR2-2 for 960 kHz, N_{GSCN}^{Step}=1.

For yet another example, if a UE detects a first SS/PBCH block and determines that a CORESET for Type0-PDCCH CSS set is not present and for a range of values for k_{SSB} (e.g., 24≤k_{SSB}≤29 for FR1 and/or 12≤k_{SSB}≤13 for FR2), the UE may determine the nearest (in the corresponding frequency direction) global synchronization channel number (GSCN) of a second SS/PBCH block having a CORESET for an associated Type0-PDCCH CSS set as N_{GSCN}^{Reference}+f(N_{GSCN}^{Offset}). N_{GSCN}^{Reference} is the GSCN of the first SS/PBCH block and N_{GSCN}^{Offset} is determined based on a value of k_{SSB} and higher layer parameter pdcch-ConfigSIB1 (including controlResourceSetZero and searchSpaceZero) provided by a first SS/PBCH block (e.g., the mapping between the combination of k_{SSB} and controlResourceSetZero and searchSpaceZero in pdcch-ConfigSIB1 to NN_{GSCN}^{Offset} is given by TABLE 1 for FR1, or TABLE 2 for FR2).

In one further consideration, this example can be applicable to operation with shared spectrum channel access.

In another further consideration, this example can be applicable to both operation with shared spectrum channel access and operation without shared spectrum channel access.

In one sub-example, for FR1, f(N_{GSCN}^{Offset})=N_{GSCN}^{Offset}.

In another sub-example, for FR2, f(N_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, and f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, e.g., the applicable synchronization raster entries per operating band are given by TS 38.104 or TS 38.101-2.

In yet another sub-example, for FR2-1, f(N_{GSCN}^{Offset})=N_{GSCN}^{Offset}.

In yet another sub-example, for FR2-2, f(N_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, and f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, according to the SCS of the SS/PBCH block (e.g., the first and/or the second SS/PBCH block), e.g., the applicable synchronization raster entries per operating band are given by TS 38.104 or TS 38.101-2.

In yet another sub-example, for all frequency ranges, f(N_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, and f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, according to the SCS of the SS/PBCH block (e.g., the first and/or the second SS/PBCH block), e.g., given by TS 38.104 or TS 38.101-2 for FR2, or by TS 38.104 or TS 38.101-1 for FR1.

For yet another example, if a UE detects a first SS/PBCH block and determines that a CORESET for Type0-PDCCH CSS set is not present and for a range of values for k_{SSB} (e.g., 24≤k_{SSB}≤30 for FR1 and/or 12≤k_{SSB}≤14 for FR2), the UE may determine the nearest (in the corresponding frequency direction) global synchronization channel number (GSCN) of a second SS/PBCH block having a CORESET for an associated Type0-PDCCH CSS set as N_{GSCN}^{Reference}+f(N_{GSCN}^{Offset}). N_{GSCN}^{Reference} is the GSCN of the first SS/PBCH block and N_{GSCN}^{Offset} is determined based on a value of k_{SSB} and higher layer parameter pdcch-ConfigSIB1 (including controlResourceSetZero and searchSpaceZero) provided by a first SS/PBCH block.

In one further consideration, this example can be applicable to operation with shared spectrum channel access.

In another further consideration, this example can be applicable to both operation with shared spectrum channel access and operation without shared spectrum channel access.

In one sub-example, for FR1, the mapping between the combination of k_{SSB} and controlResourceSetZero and searchSpaceZero in pdcch-ConfigSIB1 to N_{GSCN}^{Offset} is given by at least one of TABLE 3 to TABLE 10, wherein X₁ is an integer in the tables applicable, e.g., X₁=832.

In another sub-example, for FR2 or FR2-2, the mapping between the combination of k_{SSB} and controlResourceSetZero and searchSpaceZero in pdcch-ConfigSIB1 to N_{GSCN}^{Offset} is given by at least one of TABLE 11 to TABLE 18, wherein X₂ is an integer in the tables applicable, e.g., X₂=285.

In one sub-example, for FR1, f(N_{GSCN}^{Offset})=N_{GSCN}^{Offset}.

In another sub-example, for FR2, f(N_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, according to the SCS of the SS/PBCH block (e.g., the first and/or the second SS/PBCH block), e.g., the applicable synchronization raster entries per operating band are given by TS 38.104 or TS 38.101-2.

In yet another sub-example, for FR2-1, f(N_{GSCN}^{Offset})=N_{GSCN}^{Offset}.

In yet another sub-example, for FR2-2, f(NN_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, and f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, according to the SCS of the SS/PBCH block (e.g., the first and/or the second SS/PBCH block), e.g., the applicable synchronization raster entries per operating band are given by TS 38.104 or TS 38.101-2.

In yet another sub-example, for all frequency ranges, f(N_{GSCN}^{Offset}) is the (N_{GSCN}^{Offset})-th applicable synchronization raster entries per operating band in a higher frequency direction comparing to N_{GSCN}^{Reference} if N_{GSCN}^{Offset}>0, and f(N_{GSCN}^{Offset}) is the (−N_{GSCN}^{Offset})-th applicable synchronization raster entries per operating band in a lower frequency direction comparing to N_{GSCN}^{Reference} if N_{GSCN}^{Offset}<0, according to the SCS of the SS/PBCH block (e.g., the first and/or the second SS/PBCH block), e.g., given by TS 38.104 or TS 38.101-2 for FR2, or by TS 38.104 or TS 38.101-1 for FR1.

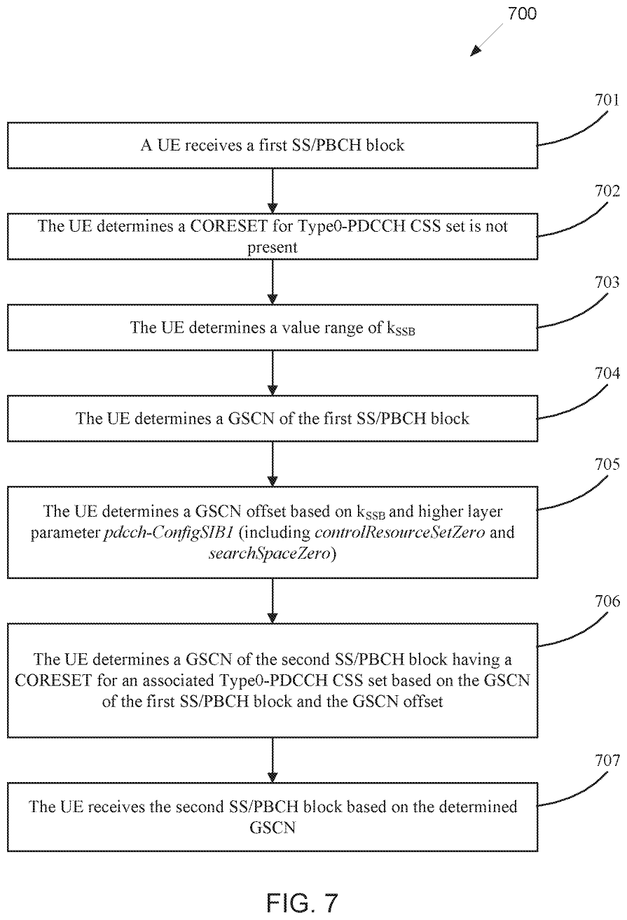

FIG. 7 illustrates a flowchart of a method 700 for UE procedure for determining the frequency location of a second SS/PBCH block based on the information of a first SS/PBCH block according to embodiments of the present disclosure. The method 700 as may be performed by a UE (e.g., 111-116 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

In one embodiment, an example UE procedure for determining the frequency location of the second SS/PBCH block based on the information from the first SS/PBCH block is shown in FIG. 7. A UE receives a first SS/PBCH block (701) and determines that a CORESET for Type0-PDCCH CSS set is not present (702). The UE determines a range of values for k_{SSB} (703) according to the example of this disclosure, and for that range of values for k_{SSB}, the UE determines a GSCN of the first SS/PBCH block (704), and a GSCN offset based on a value of k_{SSB} and higher layer parameter pdcch-ConfigSIB1 (including controlResourceSetZero and searchSpaceZero) provided by the first SS/PBCH block (705), e.g., according to at least one example and/or at least one sub-example described in this disclosure. The UE may determine the GSCN of a second SS/PBCH block having a CORESET for an associated Type0-PDCCH CSS set based on the GSCN of the first SS/PBCH block and the GSCN offset (706), and receives the second SS/PBCH block based on the determined GSCN (707).

NR Rel-17 supports search space set group (SSSG) switching for UE power savings, where gNB can group any applicable search space sets and trigger PDCCH monitoring according to a SSSG. Rel-17 SSSG switching scheme can be applied to both FR1 and FR2 including above 52.6 GHz. For above 52.6 GHz, NR supports multi-slot PDCCH monitoring capability based on one or multiple combinations (Xs, Ys). Therefore, whether or not to support adaptation on multi-slot PDCCH monitoring based on SSSG switching is a remaining issue for applying SSSG switching for above 52.6 GHz.

It is beneficial to support adaptation on multi-slot PDCCH monitoring capability based on SSSG switching in terms of higher power saving gain. For adaptation on multi-slot PDCCH monitoring based on SSSG switching, UE can determine the combination (Xs, Ys) for multi-slot PDCCH monitoring per SSSG. For example, gNB may configure SSSGs, where the combination (Xs, Ys) for SSSG #0 can be larger than the combination (Xs, Ys) for SSSG #1. When UE is triggered to switch from SSSG #1 to SSSG #0 for PDCCH monitoring, UE achieves higher power saving gain if the UE also adapts to the combination (Xs, Ys) with large applicable value which indicates relaxed PDCCH processing.

Similar as SSSG switching, adaptation on multi-slot PDCCH monitoring can be supported based on BWP switching. UE can determine the combination (Xs, Ys) for multi-slot PDCCH monitoring per BWP. For example, gNB may configure multiple BWPs for a serving cell, wherein combination (Xs, Ys) for configured search space sets in BWP #0 can be larger than the combination (Xs, Ys) for configured search space sets in BWP #1. When UE is triggered to switch from BWP #1 to BWP #0 for PDCCH monitoring, UE achieves higher power saving gain if the UE also adapts to the combination (Xs, Ys) with large applicable value which indicates relaxed PDCCH processing.

One issue to support adaptation on multi-slot PDCCH monitoring based on SSSG switching or BWP switching is back-to-back monitoring issue. During the transition period of switching SSSGs or BWP, the configured PDCCH monitoring occasions (MOs) from old active SSSG/BWP and new active SSSG/BWP may occur back to back. UE may miss detecting some PDCCHs during the transition time when back-to-back MOs occur.

To avoid back-to-back monitoring issue, the adaptation on multi-slot PDCCH monitoring can be triggered based on adaptation on associated PDCCH monitoring gap, Xs. After receiving the adaptation request on applicable value for Xs, the UE can adjust the PDCCH monitoring periodicity based on indicated Xs accordingly.

Therefore, there is a need to determine adaptation on PDCCH monitoring capability based on SSSG switching.

There is another need to determine adaptation on PDCCH monitoring capability based on BWP switching.

There is yet another need to determine adaptation on PDCCH monitoring capability based on adaptation on PDCCH monitoring gap, Xs.

The disclosure relates to a pre-5G or 5G communication system to be provided for supporting higher data rates beyond 4G communication system such as LTE. The disclosure relates to determining adaptation on PDCCH monitoring capability based on SSSG switching. The disclosure also relates to determining adaptation on PDCCH monitoring capability based on BWP switching. The disclosure finally relates to determining adaptation on PDCCH monitoring capability based on adaptation on minimum PDCCH monitoring gap, Xs.

A PDCCH monitoring capability includes a maximum number of PDCCH candidates, M_{PDCCH}^{max,μ}, and a maximum number of non-overlapping CCEs, C_{PDCCH}^{max,μ}, wherein, μ is SCS configuration of an active DL BWP where the UE expects to receive PDCCHs. The PDCCH monitoring capability is associated with a minimum PDCCH monitoring gap in terms of a number of Xs slots/symbols and/or a maximum PDCCH monitoring duration in terms of a number of Ys slots/symbols. For the benefit of simplicity of expression, we consider the PDCCH monitoring capability in terms of M_{PDCCH}^{max,μ}, and C_{PDCCH}^{max,μ}, is associated with a combination (Xs, Ys) in following embodiment. Any of the design in the following embodiment also applies to the case when the PDCCH monitoring capability is only associated with Xs or Ys.

For an applied PDCCH monitoring capability, the UE does not expect to receive a total number of PDCCH candidates, M_{PDCCH}^{max,μ}, larger than M_{PDCCH}^{max,μ}, and corresponding non-overlapping CCEs, C_{PDCCH}^{tot,μ}, larger than C_{PDCCH}^{tot,μ} per group of Xs slots/symbols.

A first embodiment of the disclosure considers adaptation on PDCCH monitoring capability based on SSSG switching.

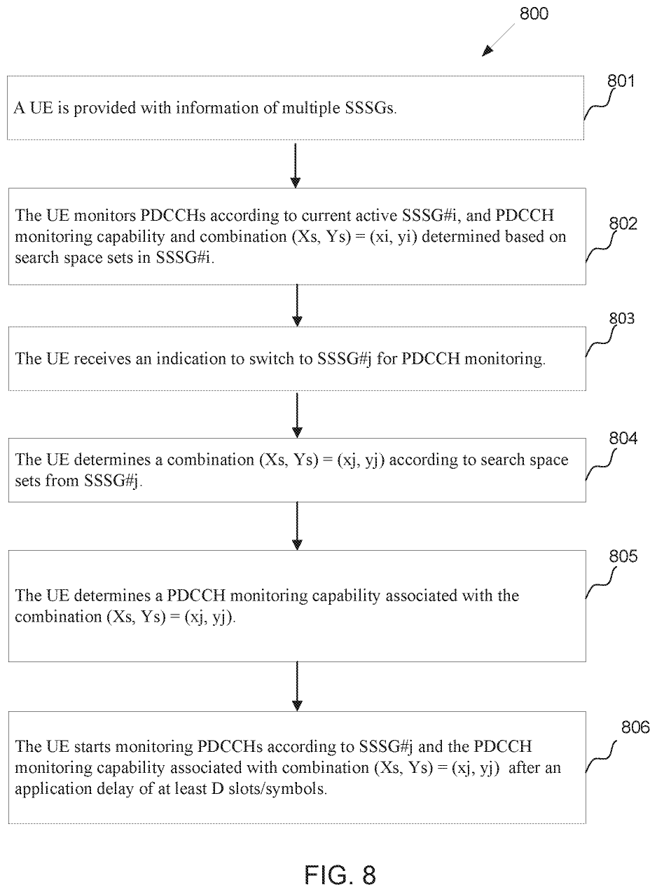

FIG. 8 illustrates a flowchart of a method 800 for UE according to embodiments of the present disclosure. The method 1400 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

FIG. 8 illustrates UE procedure for adaptation on PDCCH monitoring capability based on SSSG switching.

As illustrated in FIG. 8, a UE is provided with information of N>=2 SSSGs, 801. The UE monitors PDCCHs according to current active SSSG with index i, SSSG #i, from the N>=2 SSSGs, and PDCCH monitoring capability and combination (Xs, Ys)=(xi, yi), where xi and yi are the applicable values for Xs and Ys, respectively, and they are determined based on the configuration(s) of search space set(s) from SSSG #i. The UE then receives an indication to monitor PDCCHs according to another SSSG with index j, SSSG #j, from the N>=2 SSSGs, in slot, e.g., with index n, 803.

The UE determines applicable values for the combination (Xs, Ys)=(xj, yj) according to the configuration(s) of search space set(s) from the SSSG #j, 804. The UE further determines a PDCCH monitoring capability in terms of M_{PDCCH}^{tot,μ}, and C_{PDCCH}^{tot,μ}, that is associated with the combination (Xs, Ys)=(xj, yj), 805. The UE starts monitoring PDCCHs according to search space set(s) from the indicated SSSG #j, and stops monitoring PDCCH according to other SSSGs (e.g., SSSGs other than SSSG #j) from the N>=2 SSSGs at beginning of a slot (e.g., detail of the slot is according to example of this disclosure) that is at least D slots/symbols after the slot n, or after the last symbol of the physical layer signal/channel that provides the indication, 806, wherein D is an application delay in terms of a number of D slots/symbols for applying the indication of SSSG switching.

A UE can receive the information of N>=2 SSSGs for a DL BWP based on at least one of the following examples.

In one example, a UE receives an index of the SSSG within the N>=2 SSSGs for each applicable search space set in the configuration of the applicable search space set.

In another example, the UE assumes a SSSG is associated with a predetermined set of one or more RNTI(s), wherein UE decodes DCI formats in search space sets from the SSSG with CRC bits scrambled by any of the one or more RNTIs. The UE assumes i-th SSSG, SSSG #i, is associated with i-th set of RNTI(s). For example, a first set of RNTIs includes any of C-RNTI, CS-RNTI, and MCS-RNTI.

In yet another example, the UE assumes a SSSG is associated with a predetermined set of one or more DCI formats, wherein UE decodes the one or more DCI formats in search space sets from the SSSG. The UE assumes i-th SSSG, SSSG #i, is associated with i-th set of DCI format(s). For example, a first set of DCI formats includes any of DCI format to schedule PDSCH reception, and a second set of DCI formats includes any of DCI format to schedule PUSCH transmission. For another example, a first set of DCI formats include any of DCI format 0_0/1_0/0_1/1_1, and a second set of DCI format include any of DCI format 0_2/1_2.

When a UE reports a capability to support multiple applicable values for the combination (Xs, Ys), the UE can assume a restriction of the configuration for all search space sets from the N>=2 SSSGs in a serving cell or in an active DL BWP of a serving cell, such that all search space sets from the N>=2 SSSGs in the active BWP satisfies a common applicable value, (x0, y0), for the combination (Xs, Ys).

In one example, the UE can determine that the common applicable value (x0, y0) for the combination (Xs, Ys), wherein x0 is the smallest value among the multiple applicable values for Xs, and y0 is the largest value among the multiple applicable values for Ys. In one sub-example, when UE reports to gNB to support both (4, 1) and (8, 2) for the combination (Xs, Ys), the UE assumes all the search space sets from the N>=2 SSSGs of active DL BWP in a serving cell or in an active DL BWP of a serving cell stratifies the combination (Xs, Ys)=(x0, y0)=(4, 2).

In another example, the UE can determine the common applicable value (x0, y0) for the combination (Xs, Ys) according to the following procedure: the UE first determines x0 as the smallest value among the values for Xs within all applicable value(s) of the combination (Xs, Ys), and the UE then determines y0 as the largest value among the values for Ys within all applicable value(s) of the combination (Xs, Ys) with Xs=x0. In one sub-example, when UE reports to gNB to support (4, 1), (4, 2) and (8, 1) for the combination (Xs, Ys), the UE assumes all the search space sets from the N>=2 SSSGs of active DL BWP in a serving cell or in an active DL BWP of a serving cell stratifies the combination (Xs, Ys)=(x0, y0)=(4, 2).

When a gNB receives multiple values for combination (Xs, Ys), e.g., based on UE's reporting, the gNB can configure all search space sets from the N>=2 SSSGs in a serving cell or in an active DL BWP of a serving cell with a restriction that all search space sets from the N>=2 SSSGs in the active BWP satisfies a common applicable value, (x0, y0), for the combination (Xs, Ys).

In one example, the gNB determines the common applicable value (x0, y0) for the combination (Xs, Ys) according to the following procedure: the gNB first determines x0 as the smallest value among the values for Xs within all applicable value(s) of the combination (Xs, Ys), and the gNB then determines y0 as the largest value among the values for Ys within all applicable value(s) of the combination (Xs, Ys) with Xs=x0. In one sub-example, when UE reports to gNB to support (4, 1), (4, 2) and (8, 1) for the combination (Xs, Ys), the gNB can configure all the search space sets from the N>=2 SSSGs of active DL BWP in a serving cell or in an active DL BWP of a serving cell stratifying the combination (Xs, Ys)=(x0, y0)=(4, 2).

In another example, the gNB determines the common applicable value (x0, y0) for the combination (Xs, Ys) according to any reported value of (Xs, Ys).

For an active SSSG, SSSG #i, in an active DL BWP with SCS configuration, the UE determines applicable values, (xi, yi), for the combination (Xs, Ys) according to the configuration of search space sets from the active SSSG #i, such that (Xs, Ys)=(xi, yi). The UE also determines a PDCCH monitoring capability in terms of a maximum number of PDCCH candidates, M_{PDCCH}^{max,μ}, and a maximum number of non-overlapping CCEs, C_{PDCCH}^{max,μ} associated with the combination (Xs,Ys)=(xi, yi). The UE does not expect to receive a total number of PDCCH candidates, M_{PDCCH}^{tot,μ}, that is larger than M_{PDCCH}^{max,μ}, and corresponding non-overlapping CCEs, C_{PDCCH}^{tot,μ}, that is larger than C_{PDCCH}^{max,μ} per group of Xs=xi slots/symbols.

The UE can receive an indication for SSSG switching based one at least one of the following examples.

In one example, the UE receives the indication in a PDCCH. In one example, the PDCCH includes a DCI format to schedule a PDSCH or PUSCH. In another example, the PDCCH is received in a common search space without scheduling any PDSCH or PUSCH. In yet another example, the PDCCH includes a DCI format with CRC bits scrambled by a G-RNTI.

In one example, the UE receives the indication in a PDSCH by higher layer signaling. For example, the indication can be provided to UE as an MAC CE. For another example, the indication can be provided by RRC signaling, where the indicated SSSG is a default SSSG for PDCCH monitoring.

In one example, the UE receives the indication in a broadcast or multicast PDSCH.

When a UE receives an indication indicating switching from current active SSSG #i to another SSSG #j for PDCCH monitoring, the UE applies the indication at beginning of a first slot, of a slot group of X slots, that is at least D slots/symbols after the last slot/symbol of a physical layer signal/channel that carries the indication. The UE determines the value of X based on one of the following examples.

In one example, X equals to the applicable value of Xs determined based on the configuration of search space sets from SSSG #i.

In one example, X equals to the applicable value of Xs determined based on the configuration of search space sets from SSSG #j.

In one example, X equals to the larger value of the applicable values for the minimum PDCCH monitoring gap, Xs, that are determined based on the configuration of search space sets from SSSG #i and SSSG #j, respectively.

In one example, X equals to the smaller value of the applicable values for the minimum PDCCH monitoring gap, Xs, that are determined based on the configuration of search space sets from SSSG #i and SSSG #j, respectively.

During the transition period for switching from SSSG #i to SSSG #j, wherein the transition period starts from the last symbol/slot of the physical layer signal/channel that carries the indication and the slot that the UE applies the indication (e.g., detail of the slot can be according to example of this disclosure), the UE determines one of the following examples PDCCH monitoring behavior during the transition period.

In one example, the UE does not expect to receive any PDCCH according to any of the N>=2 SSSGs during the transition period.

In one example, the UE monitors PDCCH according to search space sets from SSSG #i during the transition period.

In one example, the UE monitors PDCCH according to search space sets from SSSG #i during the transition period except for the last Z slots/symbols. For the last Z slots/symbols the UE does not expect to receive any PDCCH according to SSSG #i or any of the N>=2 SSSGs.

In one example, Z is the applicable value for the minimum PDCCH monitoring gap, Xs, that is determined based on the configuration of search space sets from SSSG #i.

In another example, Z is the applicable value for the minimum PDCCH monitoring gap, Xs, that is determined based on the configuration of search space sets from SSSG #j.

In yet another example, Z is the larger value of the applicable values for the minimum PDCCH monitoring gap, Xs, that are determined based on the configuration of search space sets from SSSG #i and SSSG #j, respectively.

In yet another example, Z is the smaller value of the applicable values for the minimum PDCCH monitoring gap, Xs, that are determined based on the configuration of search space sets from SSSG #i and SSSG #j, respectively.

After the UE applies the indication to switch PDCCH monitoring from current SSSG #i to another SSSG, e.g., SSSG #j, starting from the slot that the UE applies the indication (e.g., detail of the slot can be according to example of this disclosure), ns, the UE can skip PDCCH monitoring or drop PDCCH monitoring occasions of search space sets from SSSG #j for a group of xj slot(s) starting from the slot that the UE applies the indication (e.g., detail of the slot can be according to example of this disclosure), ns. xj is the applicable value for Xs determined based on the configuration of search space sets from SSSGj.

The UE can determine the application delay in terms of D slots/symbols based on at least one of the following examples.

In one example, D is predetermined in the specification of system operation as a UE capability. One or more UE capabilities can be defined in the specification of system operation.

In one example, D is provided to UE by higher layers. For example, D is provided via a RRC configuration parameter.

In one example, D is determined based on a UE capability report, where the UE transmits the report to gNB in advance.

A second embodiment of the disclosure considers adaptation on PDCCH monitoring capability based on BWP switching.

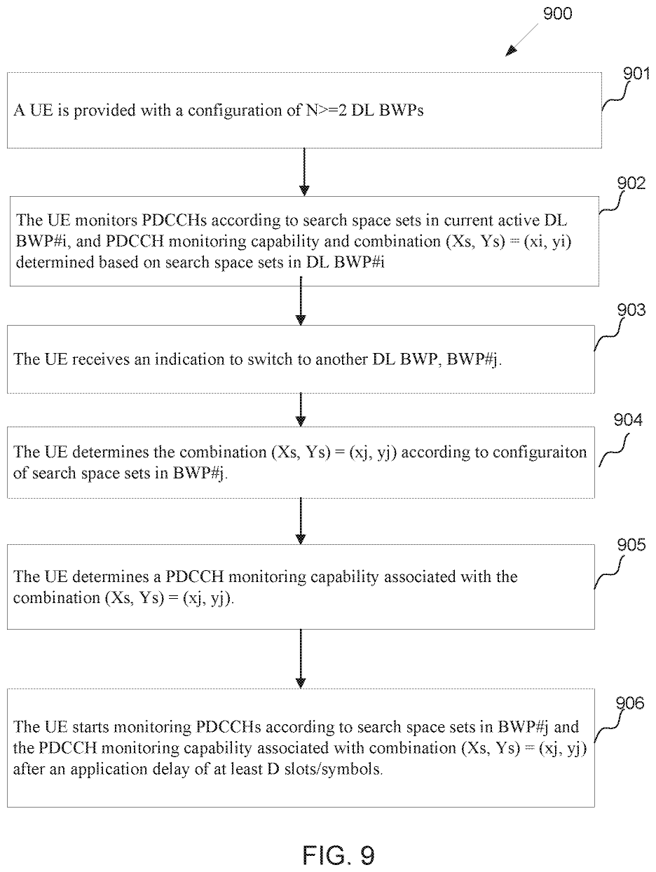

FIG. 9 illustrates another flowchart of a method 900 for UE according to embodiments of the present disclosure. The method 900 as may be performed by a UE (e.g., 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

FIG. 9 illustrates UE procedure for adaptation on PDCCH monitoring capability based on BWP switching.

As illustrated in FIG. 9, a UE is provided with a configuration of N>=2 DL BWPs, 901. The UE monitors PDCCHs according to search space sets in current active DL BWP, BWP #i from the N>=2 BWPs, and PDCCH monitoring capability and combination (Xs, Ys)=(xi, yi), where xi and yi are the applicable values for Xs and Ys, respectively, and they are determined based on the configuration of search space sets in BWP #i. The UE then receives an indication indicating switch to a DL BWP with index j, BWP #j, in slot, e.g., with index n, 903. The UE determines applicable values for the combination (Xs, Ys)=(xj, yj) according to the configuration of search space sets in BWP #j, 904. The UE further determines a PDCCH monitoring capability in terms of M_{PDCCH}^{tot,μ}, and C_{PDCCH}^{tot,μ}, that is associated with the combination (Xs, Ys)=(xj, yj), 905. The UE starts monitoring PDCCHs according to search space set(s) in BWP #j, at beginning of a slot (e.g., detail of the slot is according to example of this disclosure) that is at least D slots/symbols after the slot n, or the last symbol of the physical layer signal/channel that provides the indication, 906, wherein D is an application delay in terms of a number of D slots/symbols for applying the indication of BWP switching.

The UE can receive an indication for BWP switching based one at least one of the following examples.

In one example, the UE receives the indication in a PDCCH. In one example, the PDCCH includes a DCI format to schedule a PDSCH or PUSCH. In another example, the PDCCH is received in a common search space without scheduling any PDSCH or PUSCH. In yet another example, the PDCCH includes a DCI format with CRC bits scrambled by a G-RNTI.

In one example, the UE receives the indication in a PDSCH by higher layer signaling. For example, the indication can be provided to UE as an MAC CE. For another example, the indication can be provided by RRC signaling, where the indicated DL BWP is a default DL BWP for PDCCH and/or PDSCH reception.

In one example, the UE receives the indication in a broadcast or multicast PDSCH.

For an active DL BWP with index i, BWP #i, and SCS configuration, μ, the UE determines applicable values, (xi, yi), for the combination (Xs, Ys) according to the configuration of search space sets in the active DL BWP, BWP #i, such that (Xs, Ys)=(xi, yi). The UE also determines a PDCCH monitoring capability in terms of a maximum number of PDCCH candidates, M_{PDCCH}^{max,μ}, and a maximum number of non-overlapping CCEs, C_{PDCCH}^{max,μ} associated with the combination (Xs,Ys)=(xi, yi). The UE does not expect to receive a total number of PDCCH candidates, M_{PDCCH}^{tot,μ}, that is larger than M_{PDCCH}^{max,μ}, and corresponding non-overlapping CCEs, C_{PDCCH}^{tot,μ}, that is larger than C_{PDCCH}^{max,μ} per group of Xs=xi slots/symbols.

When a UE receives an indication indicating switching from current active DL BWP, BWP #i to another BWP, BWP #j for at least PDCCH monitoring, the UE applies the indication at beginning of a first slot, of a slot group of X slots, that is at least D slots/symbols after the last slot/symbol of a physical layer signal/channel that carries the indication. The UE determines the value of X based on one of the following examples.

In one example, X equals to the applicable value of Xs determined based on the configuration of search space sets in BWP #i.

In one example X equals to the applicable value of Xs determined based on the configuration of search space sets in BWP #j.

In one example, X equals to the larger value of the applicable values for the minimum PDCCH monitoring gap, Xs, that are determined based on the configuration of search space sets from BWP #i and BWP #j, respectively.

In one example, X equals to the smaller value of the applicable values for the minimum PDCCH monitoring gap, Xs, that are determined based on the configuration of search space sets from BWP #i and BWP #j, respectively.

During the transition period for switching from BWP #i to BWP #j, wherein the transition period starts from the last symbol/slot of the physical layer signal/channel that carries the indication and the slot that the UE applies the indication (e.g., detail of the slot can be according to example of this disclosure), the UE determines one of the following examples regarding PDCCH monitoring behavior during the transition period.

In one example, the UE does not expect to receive any PDCCH in any of the multiple BWPs during the transition period.

In one example, the UE monitors PDCCH according to search space sets in BWP #i during the transition period.

In one example, the UE monitors PDCCH according to search space sets in BWP #i during the transition period except for the last Z slots/symbols. For the last Z slots/symbols the UE does not expect to receive any PDCCH in BWP #i or any of the N>=2 BWPs.

In one example, Z is the applicable value for the minimum PDCCH monitoring gap, Xs, that is determined based on the configuration of search space sets in BWP #i.

In another example, Z is the applicable value for the minimum PDCCH monitoring gap, Xs, that is determined based on the configuration of search space sets in BWP #j.

In yet another example, Z is the larger value of the applicable values for the minimum PDCCH monitoring gap, Xs, that are determined based on the configuration of search space sets from BWP #i and BWP #j, respectively.

In yet another example, Z is the smaller value of the applicable values for the minimum PDCCH monitoring gap, Xs, that are determined based on the configuration of search space sets from BWP #i and BWP #j, respectively.

After the UE applies the indication to switch DL BWP from current active DL BWP, BWP #i, to another DL BWP, BWP #j, starting from the slot that the UE applies the indication (e.g., detail of the slot can be according to example of this disclosure), ns, the UE can skip PDCCH monitoring or drop PDCCH monitoring occasions of search space sets in BWP #j for a group of xj slot(s) starting from the slot that the UE applies the indication (e.g., detail of the slot can be according to example of this disclosure), ns. xj is the applicable value for Xs determined based on the configuration of search space sets in BWP #j.

The UE can determine the application delay in terms of D slots/symbols based on at least one of the following examples.

In one example, D is predetermined in the specification of system operation as a UE capability. One or more UE capabilities can be defined in the specification of system operation.

In one example, D is provided to UE by higher layers. For example, D is provided via a RRC configuration parameter.

In one example, D is determined based on a UE capability report, where the UE transmits the report to gNB in advance.

A third embodiment of the disclosure considers adaptation on PDCCH monitoring capability based on adaptation on minimum PDCCH monitoring gap, Xs.

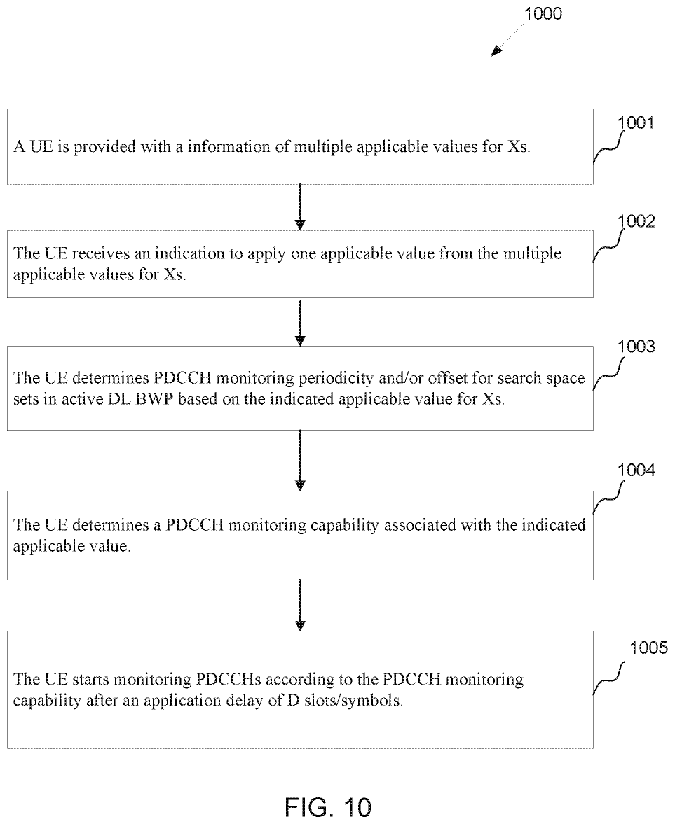

FIG. 10 illustrates yet another flowchart of a method 1000 for UE according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

FIG. 10 illustrates UE procedure for adaptation on PDCCH monitoring capability based on adaptation on minimum PDCCH monitoring gap, Xs.

As illustrated in FIG. 10, a UE is provided with information of multiple applicable values for Xs, 1001. The UE then receives an indication indicating an applicable value from the multiple applicable values in slot, n, 1002. The UE determines PDCCH monitoring periodicity and/or offset for any applicable search space set in active DL BWP based on the indicated applicable value, 1003. The UE further determines a PDCCH monitoring capability in terms of M_{PDCCH}^{tot,μ}, and C_{PDCCH}^{tot,μ}, that is associated with the indicated applicable value of Xs, 1004. The UE starts monitoring PDCCHs according to the PDCCH monitoring capability and the determined PDCCH monitoring periodicity and/or offset at beginning of a slot (e.g., detail of the slot can be according to example of this disclosure) that is at least D slots/symbols after the slot n, or the last symbol of the physical layer signal/channel that provides the indication, 1005, wherein D is an application delay in terms of a number of D slots/symbols for applying the indication.

A UE can receive the information of multiple applicable values for Xs based on at least one of the following examples.

In one example, the UE receives the multiple applicable values for Xs in a RRC configuration parameter via higher layer signaling.

In another example, the multiple applicable values for Xs are determined based on a UE capability report transmitted from UE to a gNB.

In yet another example, the multiple applicable values for Xs are predefined in the specification of system operation per SCS configuration, μ. For example, the multiple applicable values can be 4 and 8 slots for SCS configuration μ=5, or 6.

The UE can receive an indication indicating one applicable value from the multiple applicable values based one at least one of the following examples.

In one example, the UE receives the indication in a PDCCH. In one example, the PDCCH includes a DCI format to schedule a PDSCH or PUSCH. In another example, the PDCCH is received in a common search space without scheduling any PDSCH or PUSCH. In yet another example, the PDCCH includes a DCI format with CRC bits scrambled by a G-RNTI.

In one example, the UE receives the indication in a PDSCH by higher layer signaling. For example, the indication can be provided to UE as an MAC CE. For another example, the indication can be provided by RRC signaling, where the indicated applicable value is a default value for Xs.

In one example, the UE receives the indication in a broadcast or multicast PDSCH.

When a UE receives an indication indicating one applicable value, vj, the UE switches from current applicable value, vi, to vj for Xs. The UE applies the indication at beginning of a first slot, of a slot group of X slots, that is at least D slots/symbols after the last slot/symbol of a physical layer signal/channel that carries the indication. The UE determines the value of X based on one of the following examples.

In one example, X equals vi.

In one example, X equals vj.

During the transition period for switching from vi to vj for Xs, wherein the transition period starts from the last symbol/slot of the physical layer signal/channel that carries the indication and the first slot UE applies the indication, the UE determines one of the following examples regarding PDCCH monitoring behavior during the transition period.

In one example, the UE does not expect to receive any PDCCH during the transition period.

In one example, the UE receives PDCCH monitoring based on vi for Xs during the transition period.

In one example, the UE receives PDCCH monitoring based on vi for Xs during the transition period except for the last Z slots/symbols. For the last Z slots/symbols the UE does not expect to receive any PDCCH. For one example, Z=vi. For another example, Z=vj.

After the UE applies the indication to switch applicable value for Xs from vi to vj, starting from the slot that the UE applies the indication (e.g., detail of the slot can be according to example of this disclosure), ns, the UE can skip PDCCH monitoring for a group of vj slot(s) starting from the first slot, ns.

The UE can determine the application delay in terms of D slots/symbols based on at least one of the following examples.

In one example, D is predetermined in the specification of system operation as a UE capability. One or more UE capabilities can be defined in the specification of system operation.

In one example, D is provided to UE by higher layers. For example, D is provided via a RRC configuration parameter.

In one example, D is determined based on a UE capability report, where the UE transmits the report to gNB in advance.

After applying the indication for adapting applicable value, v, for Xs in an active DL BWP with SCS configuration, μ, the UE determines the PDCCH monitoring periodicity for a search space set, kₛ, and/or offset, Oₛ, based on the applicable value, v, such that kₛ=k·v, and/or Oₛ=O·v where k and O are integers that are provided to the UE by higher layer RRC signaling. The UE also determines a PDCCH monitoring capability in terms of a maximum number of PDCCH candidates, M_{PDCCH}^{max,μ}, and a maximum number of non-overlapping CCEs, C_{PDCCH}^{max,μ} associated with the applicable value v, for Xs. The UE does not expect to receive a total number of PDCCH candidates, M_{PDCCH}^{tot,μ}, that is larger than M_{PDCCH}^{max,μ}, and corresponding non-overlapping CCEs, C_{PDCCH}^{tot,μ}, that is larger than C_{PDCCH}^{max,μ} per group of Xs slots/symbols.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor configured to:
determine a value of k_{SSB} for a first synchronization signals and physical broadcast channel (SS/PBCH) block;
determine that a first control resource set (CORESET) for a Type0 physical downlink control channel (Type0-PDCCH) common search space (CSS) set is not present, wherein the first CORESET is associated with the first SS/PBCH block; and
determine a global synchronization channel number (GSCN) of a second SS/PBCH block as N_{GSCN}^{Reference}+N_{GSCN}^{Offset}·N_{GSCN}^{Step}, when the value of k_{SSB} is within a range, wherein:
a second CORESET for a Type0-PDCCH CSS set associated with the second SS/PBCH block is present;
the GSCN is a nearest GSCN in a corresponding frequency direction compared to the first SS/PBCH block;
N_{GSCN}^{Reference} is a GSCN of the first SS/PBCH block;
N_{GSCN}^{Offset} is a GSCN offset that is based on the first SS/PBCH block; and
N_{GSCN}^{Step} is a GSCN step size that is based on a frequency range associated with the wireless communication system; and
a transceiver operably coupled to the processor, the transceiver configured to:
transmit the first SS/PBCH block according to the GSCN of the first SS/PBCH block; and
transmit the second SS/PBCH block according to the GSCN of the second SS/PBCH block.

2. The BS of claim 1, wherein the range for the value of k_{SSB} is:
24≤k_{SSB}≤29 for frequency range 1 (FR1), and
12≤k_{SSB}≤13 for frequency range 2-1 (FR2-1) and frequency range 2-2 (FR2-2).

3. The BS of claim 1, wherein:
N_{GSCN}^{Offset} is based on the value of k_{SSB} and a higher layer parameter pdcch-ConfigSIB1 provided by the first SS/PBCH block, and
pdcch-ConfigSIB1 includes controlResourceSetZero and searchSpaceZero.

4. The BS of claim 1, wherein:
N_{GSCN}^{Step}=1 for frequency range 1 (FR1) and frequency range 2-1 (FR2-1), and
N_{GSCN}^{Step}=3 for frequency range 2-2 (FR2-2).

5. The BS of claim 1, wherein:
the transceiver is further configured to transmit a set of configurations by a higher layer, and
the set of configurations includes configurations for an active downlink (DL) bandwidth part (BWP) and configurations for search space sets associated with the active DL BWP.

6. The BS of claim 5, wherein:
the processor is further configured to determine, based on the configurations for the search space sets, a first value (Xs) and a second value (Ys) for monitoring PDCCH candidates;
PDCCH monitoring candidates are within a group of Ys consecutive slots; and
two consecutive groups of Ys slots are separated by Xs slots.

7. The BS of claim 6, wherein the processor is further configured to determine, based on all search space sets associated with the active DL BWP, a number of monitored PDCCH candidates and a number of non-overlapped control channel elements (CCEs) for a combination (Xs, Ys).

8. A user equipment (UE) in a wireless communication system, the UE comprising:
a transceiver configured to receive a first synchronization signals and physical broadcast channel (SS/PBCH) block; and
a processor operably coupled to the transceiver, the processor configured to:
determine a value of k_{SSB} based on the first SS/PBCH block;
determine that a first control resource set (CORESET) for a Type0 physical downlink control channel (Type0-PDCCH) common search space (CSS) set is not present, wherein the first CORESET is associated with the first SS/PBCH block; and
determine a global synchronization channel number (GSCN) of a second SS/PBCH block as N_{GSCN}^{Reference}+N_{GSCN}^{Offset}·N_{GSCN}^{Step}, when the value of k_{SSB} is within a range, wherein:
a second CORESET for a Type0-PDCCH CSS set associated with the second SS/PBCH block is present,
the GSCN is a nearest GSCN in a corresponding frequency direction compared to the first SS/PBCH block,
N_{GSCN}^{Reference} is a GSCN of the first SS/PBCH block,
N_{GSCN}^{Offset} is a GSCN offset that is based on the first SS/PBCH block, and
N_{GSCN}^{Step} is a GSCN step size that is based on a frequency range associated with the wireless communication system, and
wherein the transceiver is further configured to receive the second SS/PBCH block according to the determined GSCN of the second SS/PBCH block.

9. The UE of claim 8, wherein the range for the value of k_{SSB} is:
24≤k_{SSB}≤29 for frequency range 1 (FR1), and
12≤k_{SSB}≤13 for frequency range 2-1 (FR2-1) and frequency range 2-2 (FR2-2).

10. The UE of claim 8, wherein:
N_{GSCN}^{Offset} is determined based on the value of k_{SSB} and a higher layer parameter pdcch-ConfigSIB1 provided by the first SS/PBCH block, and
pdcch-ConfigSIB1 includes controlResourceSetZero and searchSpaceZero.

11. The UE of claim 8, wherein:
N_{GSCN}^{Step}=1 for frequency range 1 (FR1) and frequency range 2-1 (FR2-1), and
N_{GSCN}^{Step}=3 for frequency range 2-2 (FR2-2).

12. The UE of claim 8, wherein:
the transceiver is further configured to receive a set of configurations from a higher layer, and
the set of configurations includes configurations for an active downlink (DL) bandwidth part (BWP) and configurations for search space sets associated with the active DL BWP.

13. The UE of claim 12, wherein:
the processor is further configured to determine, based on the configurations for the search space sets, a first value (Xs) and a second value (Ys) for monitoring PDCCH candidates;
PDCCH monitoring candidates are within a group of Ys consecutive slots; and
two consecutive groups of Ys slots are separated by Xs slots.

14. The UE of claim 13, wherein the processor is further configured to determine, based on all search space sets associated with the active DL BWP, a number of monitored PDCCH candidates and a number of non-overlapped control channel elements (CCEs) for a combination (Xs, Ys).

15. A method of a user equipment (UE) in a wireless communication system, the method comprising:
receiving a first synchronization signals and physical broadcast channel (SS/PBCH) block;
determining a value of k_{SSB} based on the first SS/PBCH block;
determining that a first control resource set (CORESET) for a Type0 physical downlink control channel (Type0-PDCCH) common search space (CSS) set is not present, wherein the first CORESET is associated with the first SS/PBCH block;
determining a global synchronization channel number (GSCN) of a second SS/PBCH block as N_{GSCN}^{Reference}+N_{GSCN}^{Offset}·N_{GSCN}^{Step}, when the value of k_{SSB} is within a range, wherein:
a second CORESET for a Type0-PDCCH CSS set associated with the second SS/PBCH block is present,
the GSCN is a nearest GSCN in a corresponding frequency direction compared to the first SS/PBCH block,
N_{GSCN}^{Reference} is a GSCN of the first SS/PBCH block,
N_{GSCN}^{Offset} is a GSCN offset that is based on the first SS/PBCH block, and
N_{GSCN}^{Step} is a GSCN step size that is based on a frequency range associated with the wireless communication system; and
receiving the second SS/PBCH block according to the determined GSCN of the second SS/PBCH block.

16. The method of claim 15, wherein the range for the value of k_{SSB} is:
24≤k_{SSB}≤29 for frequency range 1 (FR1), and
12≤k_{SSB}≤13 for frequency range 2-1 (FR2-1) and frequency range 2-2 (FR2-2).

17. The method of claim 15, wherein:
N_{GSCN}^{Offset} is determined based on the value of k_{SSB} and a higher layer parameter pdcch-ConfigSIB1 provided by the first SS/PBCH block, and
pdcch-ConfigSIB1 includes controlResourceSetZero and searchSpaceZero.

18. The method of claim 15, wherein:
N_{GSCN}^{Step}=1 for frequency range 1 (FR1) and frequency range 2-1 (FR2-1), and
N_{GSCN}^{Step}=3 for frequency range 2-2 (FR2-2).

19. The method of claim 15, further comprising:
receiving a set of configurations from a higher layer, the set of configurations including configurations for an active downlink (DL) bandwidth part (BWP) and configurations for search space sets associated with the active DL BWP.

20. The method of claim 19, further comprising:
determining, based on the configurations for the search space sets, a first value (Xs) and a second value (Ys) for monitoring PDCCH candidates, wherein:
PDCCH monitoring candidates are within a group of Ys consecutive slots, and
two consecutive groups of Ys slots are separated by Xs slots; and
determining, based on all search space sets associated with the active DL BWP, a number of monitored PDCCH candidates and a number of non-overlapped control channel elements (CCEs) for a combination (Xs, Ys).
